(19) United States
(12) Patent Application Publication
(10) Pub. No.: US 2007/0142165 A1
(43) Pub. Date: Jun. 21, 2007

(54) Method for operating a drive system

(75) Inventors: Walter Klinkner, Stuttgart (DE); Matthias Kronewitter, Esslingen (DE); Dietrich Sahm, Bad Urach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/566,444

(22) PCT Filed: Jul. 23, 2004
(86) PCT No.: PCT/EP04/08239

§ 371 Date: Aug. 7, 2006

(30) Foreign Application Priority Data
Aug. 1, 2003 (DE) 103 35 259.7

(51) Int. Cl. B60K 1/02; B60K 6/00; F02B 73/00

(52) U.S. Cl. 477/3; 180/65.2; 60/716

(57) ABSTRACT

The invention relates to method for operating a drive system for a motor vehicle comprising an internal combustion engine (1) and an electric machine (6), it being possible to accelerate a driveshaft (4) of the internal combustion engine by means of the electric machine (6), and in the event of an upshift and/or when an upshift is initiated, an idling rotational speed of the driveshaft (4) is increased by the electric machine (6). If a turbocharger is used to increase the charge pressure, an increase in the idling rotational speed by the electric machine can compensate for low efficiency of the turbocharger at low rotational speeds.

### BACKGROUND AND SUMMARY OF THE INVENTION

This application claims the priority of German patent document 103 35 259.7, filed Aug. 1, 2003 (PCT International Application No. PCT/EP2004/008239, filed Jul. 23, 2004), the disclosure of which is expressly incorporated by reference herein.

The invention relates to a method for operating a drive system for a vehicle having both an internal combustion engine and an electric machine, it being possible to accelerate a driveshaft of the internal combustion engine by means of the electric machine.

A starter/generator for an internal combustion engine of a motor vehicle disclosed in European patent document EP 0 876 554 B1 comprises an electric three phase machine which performs both starter and generator functions. In addition, the electric machine can be used to achieve or assist an acceleration and/or braking of the driveshaft, in order to accelerate or brake the vehicle and/or to prevent slipping of a driven wheel in an anti-slip control, by braking the internal combustion engine or at least one driven wheel. The electric machine can also be used to reduce rotational irregularities of the driveshaft by virtue of the fact that for compensation purposes, it generates a rapidly alternating opposite phase torque.

In low volume internal combustion engines designed for automobiles, the reduction in torque which results from the reduced stroke volume is often compensated by means of pressure charging, for example by an exhaust gas turbocharger. In the case of an exhaust gas turbocharger, the turbine rotates more quickly as the exhaust gas flow increases, which increases the charge pressure, (that is, the pressure with which the air is forced into the combustion space of the internal combustion engine). The effect of the exhaust gas turbocharger is, however, restricted at low engine speeds and in part-load situations because of the wide span of exhaust gas and the low speed of the exhaust gas flow. This results in poor starting performance of such internal combustion engines of low stroke capacity (so-called “turbo lag”). The use of variable turbine geometry is difficult to implement in the case of a spark ignition engine with its high exhaust gas temperatures and geometric combustion, and achieves only an insignificant increase in the starting torque. Solutions having electrically assisted pressure charging systems or electrically assisted exhaust gas turbochargers are technically highly complex.

Considerable dead times occur, particularly in conjunction with automatic clutch systems, because of the low efficiency of the exhaust gas turbocharger at low rotational speed (when the vehicle starts and during shifts until the clutch can engage). In this context it is assumed that, as is generally customary, a control unit (such as an engine and/or transmission control unit) monitors the engine speed and allows complete engagement of the clutch only when it has exceeded a certain limit value. (In this manner, so-called “stalling” of the internal combustion engine after the clutch has engaged cannot occur.) In order to prevent the internal combustion engine from stalling, the clutch is typically operated in a slipping manner until the internal combustion engine speed has reached a sufficiently high speed.

One object of the invention is to provide a method for operating a drive system for a motor vehicle which achieves short clutch engagement times, particularly in the low rotational speed range.

This and other objects and advantages are achieved by the method according to the invention, in which the idling rotational speed of the driveshaft is increased by the electric machine when an upshift is initiated or in the event of an upshift.

A starter/generator or motor/generator which is already provided in the motor vehicle and can be used in particular for stop/start operation is preferably used as the electric machine. The electric machine can drive the driveshaft by means of a belt provided for this purpose. It can however also be arranged directly on the driveshaft (a so-called integrated arrangement). An electric three phase machine, such as a synchronous machine, an asynchronous machine or a reluctance machine, is preferably used.

The invention permits the vehicle clutch to be engaged earlier, without the internal combustion engine “stalling”, due to the assistance provided by the electric machine for accelerating the driveshaft, since the driveshaft rotational speed more quickly exceeds the minimum driveshaft rotational speed (described hereinabove), for engaging the clutch, thanks to the additional acceleration. A control unit therefore needs to maintain the clutch in a slipping state for less time than in the case of operation without an increase in idling rotational speed by the electric machine. Engagement of the clutch can be permitted correspondingly earlier.

Clutch engagement times when starting and during shifts can therefore be advantageously shortened both with manually operated and with automatic clutch systems and shift systems. Faster and more comfortable starting and shifting behaviour can be obtained as a result.

The method according to the invention can advantageously be used to compensate for the so-called “turbo lag”, described previously, which is caused by the low efficiency of an exhaust gas turbocharging system at low rotational speeds. The method according to the invention can however also be used at relatively high rotational speeds.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a drive system; and

FIG. 2 is a graphic illustration of representative temporal characteristics of vehicle-related variables which result with and without acceleration assistance from the electric machine.

### DETAILED DESCRIPTION OF THE DRAWINGS

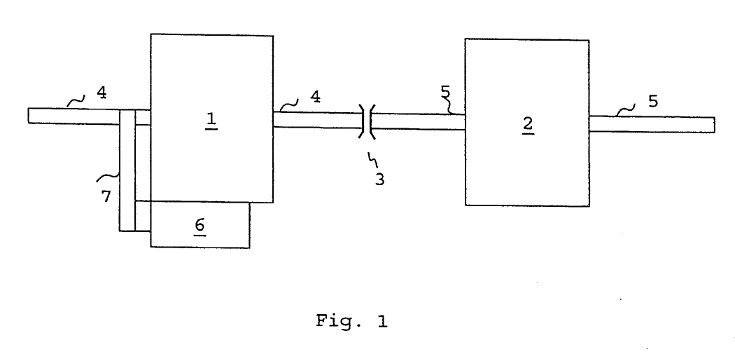

FIG. 1 shows a drive system for a motor vehicle which comprises an internal combustion engine 1 and an electric machine 6. A driveshaft or crankshaft 4 is assigned to the internal combustion engine 1 and can be connected to a transmission shaft 5 of a transmission 2 by means of a clutch 3. The electric machine 6 is preferably arranged on an engine housing, which is not indicated in more detail, and can drive the driveshaft 4 of the internal combustion engine 1 by means of a belt 7. Thus, in addition to the internal combustion engine 1, the electric machine 6 can set the driveshaft 4 in rotation and accelerate and/or brake the latter. The electric machine 6 is preferably supplied with electrical energy and controlled by a power electronic unit (not illustrated), and comprises a power converter or power inverter, and a control unit (not shown). The control unit may be a separate component, or it may also be integrated in a drive system control unit which is already present (for example an engine control unit and/or a transmission control unit).

If the clutch 3 is disengaged for a shift, it is preferably not engaged again until the (idling) rotational speed of the driveshaft 4 has reached a sufficient value, so that after the clutch 3 has engaged, the driveshaft 4 is not braked to a value at which the internal combustion engine could “stall”. A further control unit (not shown) therefore usually ensures that the clutch 3 is operated in a slipping manner until the rotational speed of the driveshaft 4 has reached a sufficiently high value at which the internal combustion engine cannot “stall” after the clutch 3 has engaged. This further control unit can be either a separate component, or integrated in a drive system control unit which is already present (for example an engine control unit, a transmission control unit, and/or a control unit for controlling the electric machine).

In the method according to the invention, when an upshift is initiated or in the event of an upshift, the electric machine 6 increases the idling rotational speed of the driveshaft 4 to a value which prevents the internal combustion engine 1 from “stalling” when the clutch 3 is engaged. Such an increase of the idling rotational speed can compensate for the low efficiency of the turbocharger at low rotational speeds. This is particularly so when an exhaust gas turbocharger that has low efficiency at low rotational speeds (and can thus contribute only a small amount to the increase in rotational speed/torque in this rotational speed range) is used to increase the charge pressure.

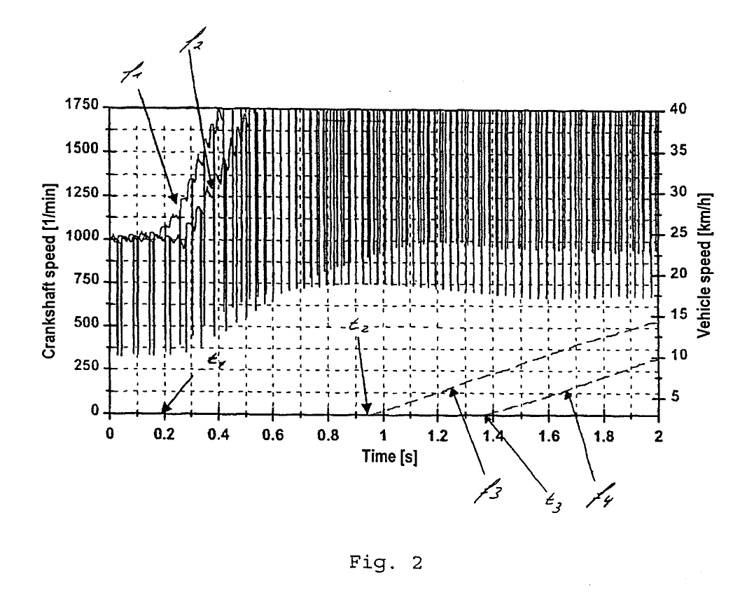

By way of example, FIG. 2 shows characteristic curves of the driveshaft rotational speed and vehicle speed as a function of time, with and without acceleration assistance from the electric machine. (Time is plotted on the abscissa.) The rotational speed is plotted on the left ordinate and the vehicle speed is plotted on the right ordinate. The characteristic curves f₁ and f₂ show rotational speed; the rotational speed characteristic f₁ is produced with acceleration assistance from the electric machine and the rotational speed characteristic f₂ is produced without acceleration assistance from the electric machine.

The characteristic curves f₃ and f₄ represent vehicle speed. The characteristic f₃ is produced with acceleration assistance from the electric machine, and the characteristic f₄ is produced without acceleration assistance from the electric machine. The brake pedal is released at 0 seconds, and full throttle is applied at the time t₁. If an electric machine is used for drive assistance, this electrical assistance comes into effect from the time t₁ onwards.

Up to the time t₁, the rotational speed characteristics f₁ and f₂ have similar, nearly constant behaviour. However, while the rotational speed characteristic f₁ effected with the use of drive assistance from the electric machine already rises at the time t₁, the rise in the rotational speed characteristic f₂ does not occur until approximately 0.08 seconds later.

The motor vehicle with drive assistance from the electric machine correspondingly starts at the time t₂ (see vehicle speed characteristic f₃), while the motor vehicle without drive assistance from the electric machine does not start until a time t₃ (see vehicle speed characteristic f₃), t₂ being smaller than t₃. According to the vehicle speed characteristics f₃ and f₄, the motor vehicle with drive assistance from the electric machine reaches a higher speed at an earlier point in time than the vehicle without drive assistance from the electric machine.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-3. (canceled)

4. A method of operating a drive system for a motor vehicle having an internal combustion engine and an electric machine which can accelerate a driveshaft of the internal combustion engine; wherein:
when the motor vehicle starts, the electric machine increases an idling rotational speed of the driveshaft of the internal combustion engine.

5. The method as claimed in claim 4, wherein the electric machine drives the internal combustion engine via a belt.

6. The method as claimed in claim 4, wherein:
an exhaust gas turbocharger is used to increase charge pressure of the internal combustion engine; and
an increase in the idling rotational speed compensates for low efficiency of the turbocharger at low rotational speeds.

7. The method as claimed in claim 5, wherein:
an exhaust gas turbocharger is used to increase charge pressure of the internal combustion engine; and
an increase in the idling rotational speed compensates for low efficiency of the turbocharger at low rotational speeds.

8. A method of operating a vehicle propulsion system in which an electric motor is coupled to a drive shaft of an internal combustion engine to propel the vehicle, said method comprising:
using said internal combustion engine to propel the vehicle;
during a disengagement of a vehicle clutch for gear shifting causing said electric motor to accelerate a rotational speed of said drive shaft; and
engaging said clutch when said rotational speed reaches a predetermined value.

9. The method according to claim 8, wherein one of the following is true:
i) the electric motor drives the internal combustion engine via a belt; and
ii) the electric motor is integrated with the drive shaft of the internal combustion engine.
